(19) United States
(12) Patent Application Publication
(10) Pub. No.: US 2003/0027615 A1
(43) Pub. Date: Feb. 6, 2003

(54) Reversi game device

(76) Inventor: KanIchi Sousumi, Tokyo (JP)

Correspondence Address: Finnegan, Henderson, Farabow,, Garrett & Dunner, L.L.P., 1300 I Street, N.W., Washington, DC, 20005-3315, US

(21) Appl. No.: 10/207,774

(22) Filed: Jul. 31, 2002

(30) Foreign Application Priority Data
Aug. 1, 2001 (JP) 2001-234120

(51) Int. Cl. A63F 13/00

(52) U.S. Cl. 463/14

(57) ABSTRACT

The invention provides a reversi game device of high playability which permits new strategic characteristics to be added to a conventional game and incorporates reversal elements up until the end of the game. The reversi game device comprises: means 3 for displaying on a screen a game board 31 divided into individual piece laying positions by a plurality of rows and columns; and means for placing a piece 32 having a prescribed color or symbol at a specified piece laying position, in accordance with a piece laying input specifying a piece laying position. The reversi game device further comprises: means S1 for moving pieces of a specified row or column with respect to the pieces of other rows or columns, in accordance with a shift input specifying a row or column; judging means S15 for judging whether or not any pieces having another color or symbol is trapped between (a) a piece laid by a piece laying input or a piece moved by said shift input and (b) another piece having the same color or symbol as that of the piece laid or moved; and means S17 for changing said trapped piece or pieces to the same color or symbol as the color or symbol of the pieces trapping same, on the basis of said judgment.

### BACKGROUND OF THE INVENTION

1. Field of the Invention

The present invention relates to a game device, and more particularly, to a game device providing new strategic characteristics in a reversi game device using a computer.

2. Description of the Related Art

A current reversi game uses a game board consisting of 64 squares in 8 rows and 8 columns, and circular, plate-shaped stones (pieces) which have different colors on the front and rear faces thereof, and the game involves trapping the opponent's pieces between (a) a piece you have just laid and (b) another piece of yours which have previously been laid on the game board, thereby causing the trapped pieces to be reversed and changed to your own color. If a modification of some kind is applied to this standard reversi, then it is called “derivative reversi”, for example, 10-row, 10-column reversi is called “perfect reversi”, whilst a reversi game in which three squares have been removed from each corner of the “perfect reversi” game board is called “octagonal reversi”.

Interesting points of a reversi game lies in being able to lay your own pieces skillfully at positions where they cannot be reversed, and in changing a large number of the opponent's pieces to your own color in a single move. However, if your opponent lays a piece at a position where it cannot be reversed, then it loses interest for you. Moreover, there was a limit in the number of pieces that may be changed to your own color in a single move.

It is an object of the present invention to provide a reversi game device of excellent playability which permits new strategies to be added to a conventional game and incorporates reversal elements up until the end of the game.

### SUMMARY OF THE INVENTION

In order to achieve the aforementioned object, the game device according to the present invention is a reversi game device comprising: means for displaying a game board divided into individual piece laying positions by a plurality of rows and columns; and means for placing a piece of a prescribed color or symbol at a specified piece laying position, in accordance with a piece laying input specifying a piece laying position; comprising: means for moving the pieces of a specified row or column with respect to the pieces of another row or column, in accordance with a shift input specifying a row or column; judging means for judging whether or not pieces of another color or symbol are trapped between a piece laid by a piece laying input or a piece moved by the shift input, and another piece of the same color or symbol; and means for changing the trapped piece or pieces to the same color or symbol as the color or symbol of the pieces trapping same, on the basis of the judgment.

In the aforementioned reversi game device, desirably, the judging means only carries out judgment of whether or not pieces are trapped in the column direction, in cases where the pieces of a specified row are moved in accordance with the shift input; and the judging means only carries out judgment of whether or not pieces are trapped in the row direction, in cases where the pieces of a specified column are moved in accordance with the shift input. Thereby, it is possible to avoid conflict between judgment results in a diagonal direction.

In the aforementioned reversi game device, desirably, the number of movements according to the shift input is limited. Thereby, it is possible to prevent the game time from becoming very long. Moreover, desirably, the number of movements according to the shift input is limited to one forward and backward movement per row or per column.

The reversi game processing method according to the present invention comprises: a step of displaying a game board divided into individual piece laying positions by a plurality of rows and columns; and a step of placing a piece of a prescribed color or symbol at a specified piece laying position, in accordance with a piece laying input specifying a piece laying position; a step of moving the pieces of a specified row or column with respect to the pieces of another row or column, in accordance with a shift input specifying a row or column; a step of judging whether or not pieces of another color or symbol are trapped between a piece laid by a piece laying input or a piece moved by the shift input, and another piece of the same color or symbol; and a step of changing the trapped piece or pieces to the same color or symbol as the color or symbol of the pieces trapping same, on the basis of the judgment.

### BRIEF DESCRIPTION OF THE DRAWINGS

FIG. 1 is a compositional view of a game device according to an embodiment of the present invention;

FIG. 2 is a flowchart showing the sequence of game processing in a game device according to the embodiment;

FIG. 3 is a flowchart showing the details of processing for moving a row or column, in the reversal judgment processing indicated at S2 in FIG. 2;

FIG. 4 is a flowchart showing the details of processing for moving a row or column, in the reversal judgment processing indicated at S2 in FIG. 2;

FIG. 5 is a flowchart showing the details of processing for moving a row or column, in the reversal judgment processing indicated at S2 in FIG. 2;

FIG. 6 is a flowchart showing the details of processing for moving a row or column, in the reversal judgment processing indicated at S2 in FIG. 2;

FIG. 7 is a flowchart showing the details of the arrow changing step indicated by S3 in FIG. 2;

FIG. 8 is a diagram showing a practical example of a game board and game development;

FIG. 9 is a diagram showing another practical example of a game board and game development;

FIG. 10 is a diagram showing still another practical example of a game board and game development; and

FIG. 11 is a diagram showing still another practical example of a game board and game development.

### DESCRIPTION OF THE PREFERRED EMBODIMENTS

Below, embodiments of the present invention are described with reference to the drawings.

Composition of the Game Device

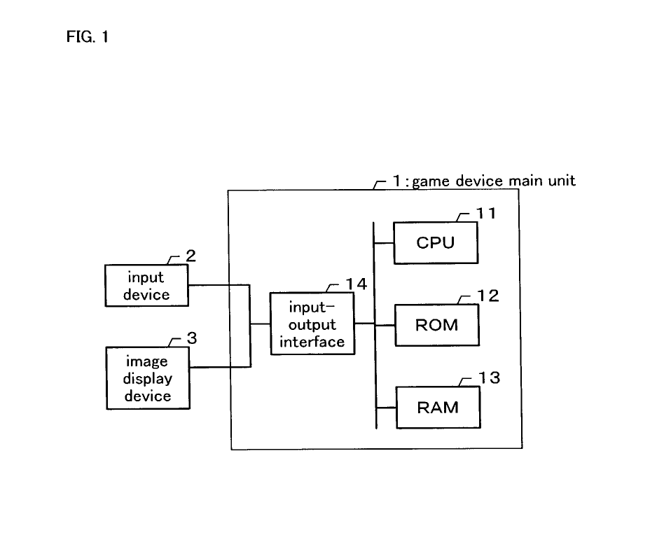

FIG. 1 is a compositional view of a game device according to an embodiment of the present invention. This game device comprises a game device main unit 1, an input device 2, and an image display device 3.

The game device main unit 1 consists of a computer, which executes game processing in accordance with a program describing a game processing sequence, on the basis of signals input from the input device 2, and causes game contents to be displayed on the image display device 3. More specifically, it comprises a ROM 12 for storing game programs, data, and the like, a CPU 11 for executing programs, a RAM 13 which is used as a temporary storage unit during operation by the CPU, and an interface 14 between the input device 2 and the image display device 3, and the like.

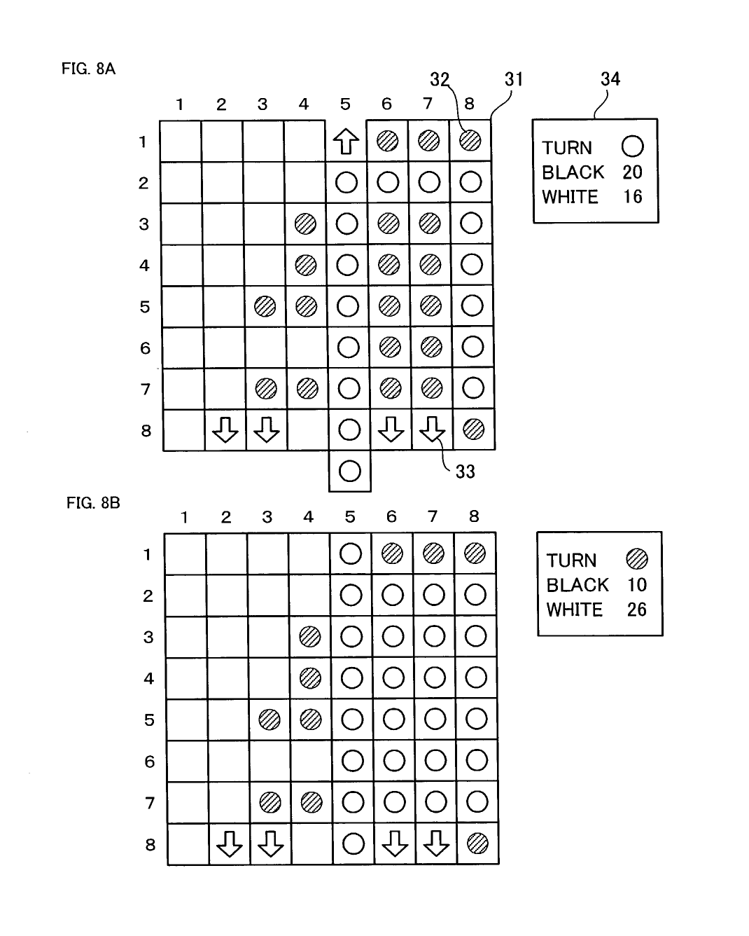

As shown by the screen examples in FIG. 8 to FIG. 11, for instance, a game board 31, pieces 32 laid on same, and arrows 33 showing that shift inputs are possible, and the like, are displayed. It is also possible to display an indication of the game progress 34, such as the number of pieces corresponding to each player currently on the game board.

The game board 31 is divided into individual piece laying positions (squares) by means of a plurality of rows and a plurality of columns intersecting with each other, and by indicating a particular row and a particular column, a particular square can be specified. The present game board 31 comprises 8 rows and 8 columns, but another size of board may also be used. For instance, it may be set to an octagonal board, as in octagonal reversi, or another shape. Moreover, in the example illustrated, the rows and columns are set orthogonally, but it is also possible for them to intersect at a different angle. Furthermore, in the present example, the piece laying positions are specified by only two axes, namely, rows and columns, but it is also possible to devise a game where the piece laying positions are specified by three axes.

The pieces 32 can be identified for each player. The identification of the pieces 32 for each player is not limited to a color distinction, and may also use distinction basic on symbols (pictures). The following description relates to an example using color-based distinction. Moreover, the shape of the pieces 32 is not limited to the flat circular shape illustrated here, but may also be set to a playing card shape, angular shape, or the like.

The arrows 33 are applied to both the rows and columns in the illustrated example. However, the arrows may be applied to either the rows or columns only, or only to some limited portions of the rows and columns. In general, the lower the number of arrows indicated, the easier the game is to play for a beginner.

The input device 2 transmits a shift input or piece laying input for the row or column played by the player to the game board, to the game device main unit 1. This input device 2 may be provided in the form of a touch panel sensor on the surface of the image display device 3. In this case, the player is able to perform an input for placing a piece by touching an empty square, and the player is able to move row or column by touching one of the arrows 33 in FIG. 8, or the like.

Processing of the Game Device

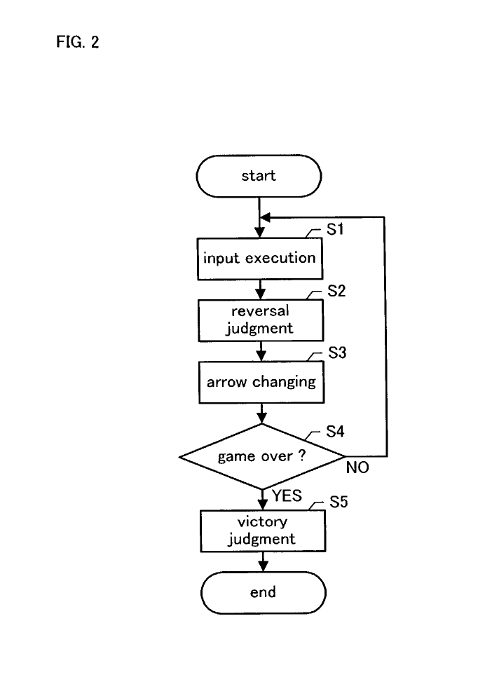

FIG. 2 is a flowchart showing the sequence of game processing in the game device according to the present embodiment. Firstly, at the input execution step (SI), the game device main unit 1 determines whether or not there has been an input to the input device 2, and it executes operations according to the input. Operations according to the input might include: placing a piece at an empty square on the game board, or moving (sliding) a piece at a specified row or column to another row or column, in units of one square, or the like. If a row or column of pieces is to be moved, then the squares belonging in that row or column are moved together.

Next, at a reversal judgment step (S2), it is judged whether or not (a) the piece newly laid or moved in accordance with the input and (b) another piece of the same color trap therebetween pieces of the other color, and whether or not the trapping pieces and the trapped pieces are arranged in continuous fashion. If the answers are affirmative, then processing for reversing the color of the trapped pieces is carried out. It is possible to set the game in such a manner that the aforementioned input is accepted, even if there is no piece to be reversed in color as a result of the reversal judgment step, or if there is no piece on the specified row or column. Thereby, it is possible to make a move of shifting a row or column only, thus expanding the range of possible strategies. Details of reversal judgment processing carried out when a row or column is moved are described later.

Next, at an arrow changing step (S3), arrows that are to be deleted as a result of the input are deleted, and arrows that are to be newly added are newly displayed. The details of this processing are described later.

At an end judgment step (S4), it is judged whether or not the game has ended. This game is regarded as having ended when pieces have been laid on all the squares of the game board, or when the squares on the game board have been turned to the color of one player only. If it is judged that the game has not ended, then the sequence returns to the input execution processing (S1).

If the game has ended, then at a victory judgment step (S5), it is judged which of the players has won the game. The victory is given to the player having the greater number of pieces of his or her color laid on the game board.

Details of Reversal Judgment Processing

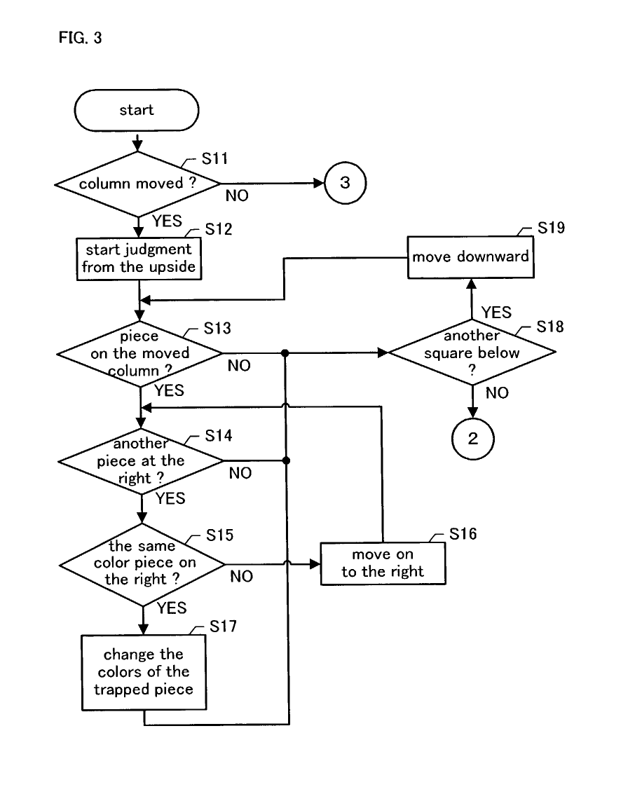

FIG. 3 to FIG. 6 are flowcharts giving the details of processing when a specified row or column is moved, in the reversal judgment processing indicated by step S2 in FIG. 2. If the pieces on a specified column have been moved one square (S11: YES), then the game device main unit 1 starts judgment in sequence from the uppermost square of the moved column.

Firstly, if a piece is positioned on the currently judged square of the moved column (S13: YES), then it is determined whether or not there is a piece adjacently to the right of that piece (S14). If there is such piece adjacently to the right and it does not have the same color as the piece in the column being moved (S15: NO), then the determination point moves one square to the right (S16), and it is then determined again whether or not there is a piece adjacently to the right (S14).

This determination process in S14 to S16 is repeated, and on the first occasion that the piece adjacently to the right is determined to be of the same color as the piece in the moved column (S15: YES), then the pieces from the piece adjacently to the right of the moved column, to the last piece judged to the right thereof (the piece adjacently to the left of the piece of the same color as the piece of the moved column), are reversed in color (S17). Thereby, it is possible to reverse all the pieces of the other color trapped between that piece and the piece of the same color in a different column. If the piece adjacently to the right of the piece in the moved column is the same color, then no pieces are reversed.

When the processing in S17 has been carried out, or if there is no piece situated in the square of the moved column (S13: NO), or if there are no more pieces adjacently to the right and no piece of the same color has yet been found to the right-hand side (S14: NO), then provided that there is a square below the square in question (S18: YES), the square to be judged is moved one square down (S19). Here, the processing from step S13 above is implemented.

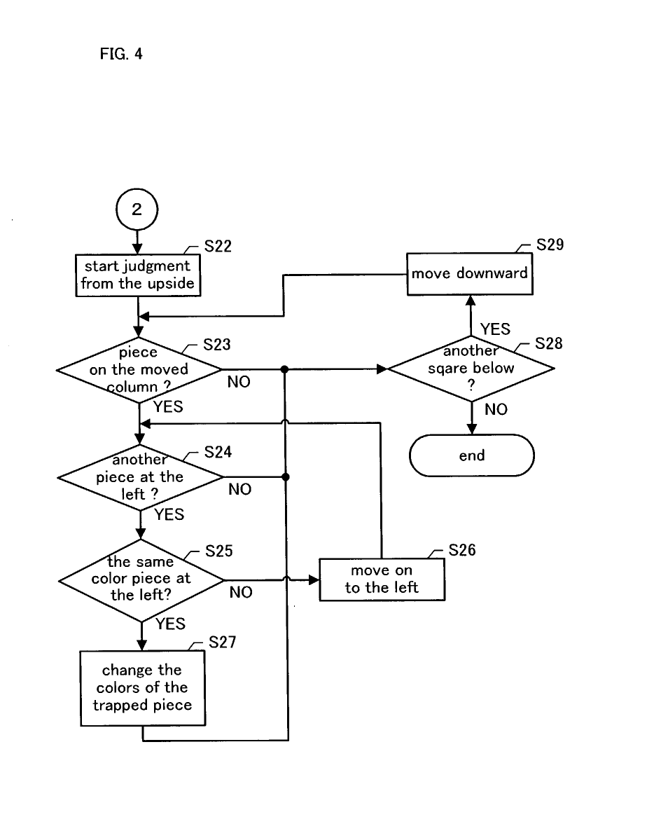

If there is no lower square to be moved (S18: NO), then as shown in FIG. 4, the same processing as that in S12 to S19 above is implemented with respect to the squares to the left-hand side of the moved column (S22-S29), whereupon the processing sequence terminates. In the foregoing processing, trapped pieces may be reversed not only in cases where one player traps the pieces of the other player as a result of moving his or her pieces, but also in cases where the opponent's pieces trap the player's pieces, as a result of the opponent's pieces having been moved. By means of this processing, it is possible to create new strategies, wherein, for instance, the opponent can more readily be ensnared by one's own strategy.

Moreover, as described above, when a movement in a column direction is performed, then it is judged whether or not other pieces are trapped in a row direction. This is because no new pieces are trapped in the column direction when a column of pieces are moved, and also because, if pieces trapped in the diagonal direction are judged, then this will conflict with the pieces trapped in the row direction by pieces of another row.

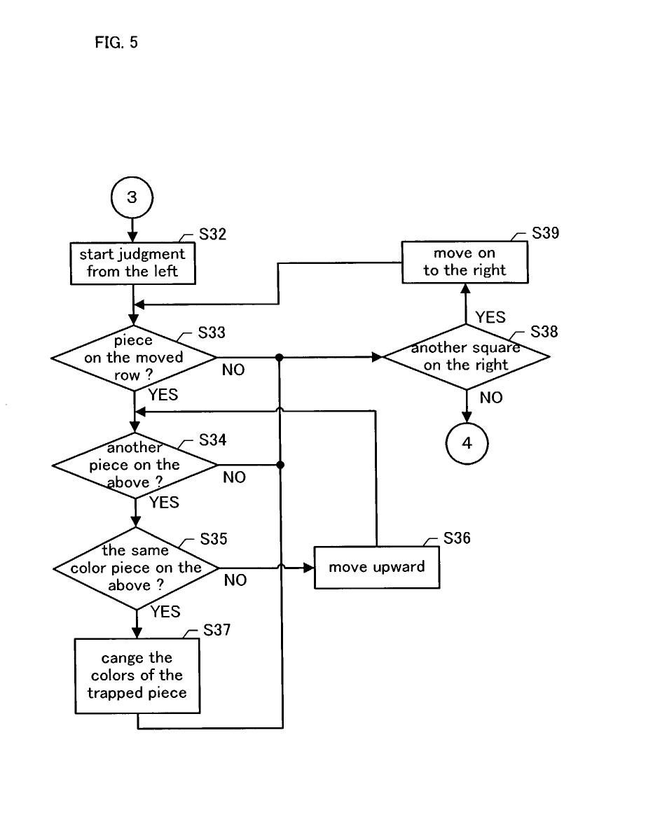

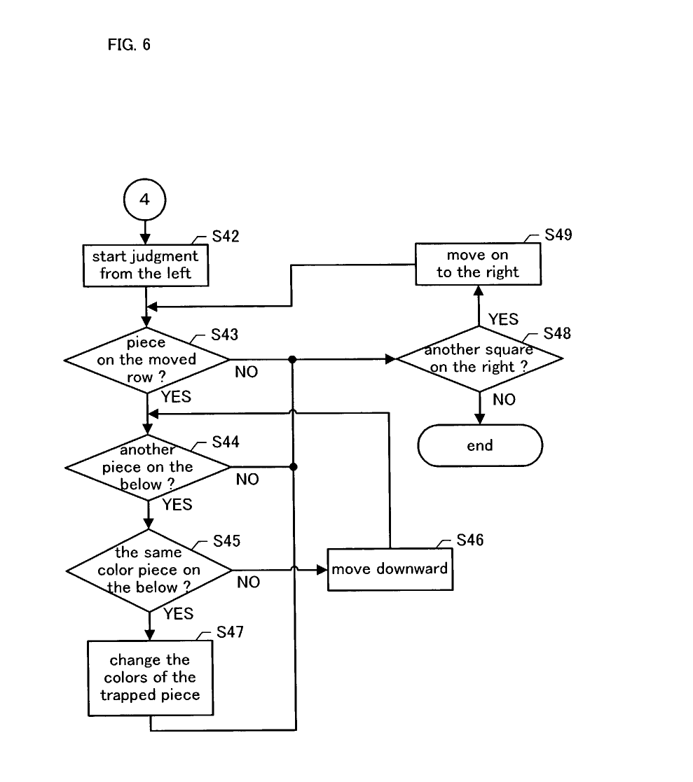

In FIG. 3, if the pieces in the specified row are moved by one square (S11: NO), then judgment starts in sequence from the leftmost square of the moved row, as in FIG. 5 (S32). After carrying out similar processing to that in steps S12 to S19 above with respect to the pieces above the moved row (S32-S39), according to FIG. 6, processing similar to that in steps S12 to S19 above is performed with respect to the pieces below the moved column (S42-S49), whereupon the processing sequence terminates.

Details of Arrow Changing Step

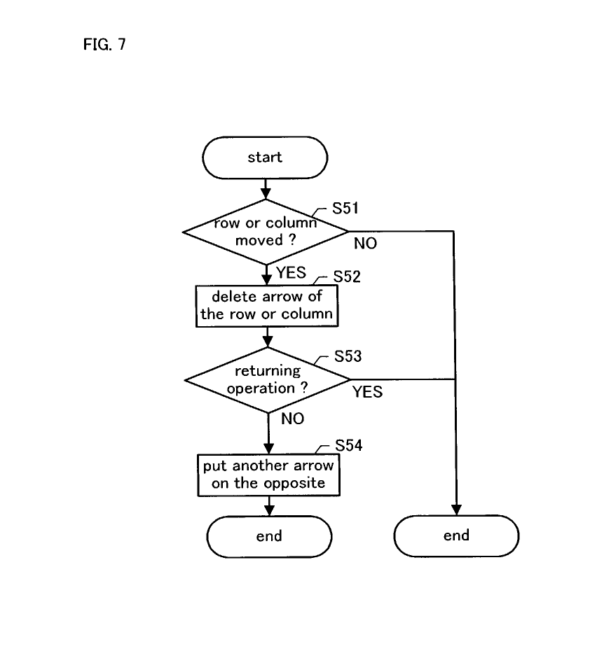

FIG. 7 is a flowchart showing the details of an arrow changing step indicated by S3 in FIG. 2. If the pieces of a specified row or column are moved (S51), the arrow 33 of the specified row or column is deleted (S52). Accordingly, in this embodiment, the same row or column is never moved consecutively in the same direction. Moreover, a row or column cannot be moved by two or more squares. By prohibiting the movement of the same row or column in the same direction in this way, it is possible to prevent the shape of the game board from becoming complex and to prevent the game from becoming complicated.

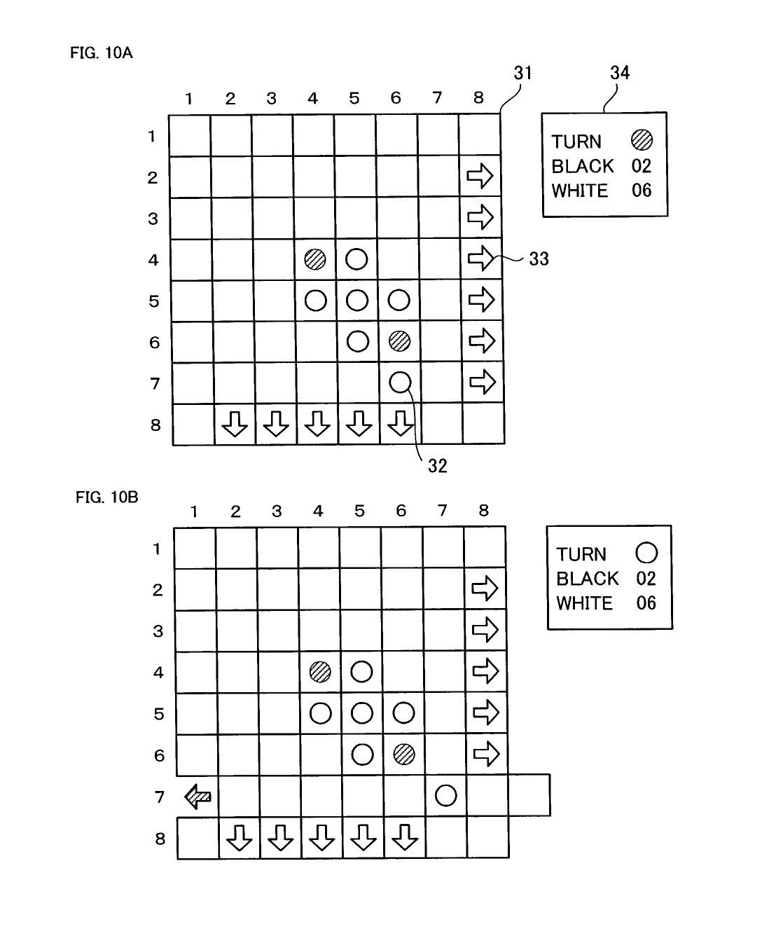

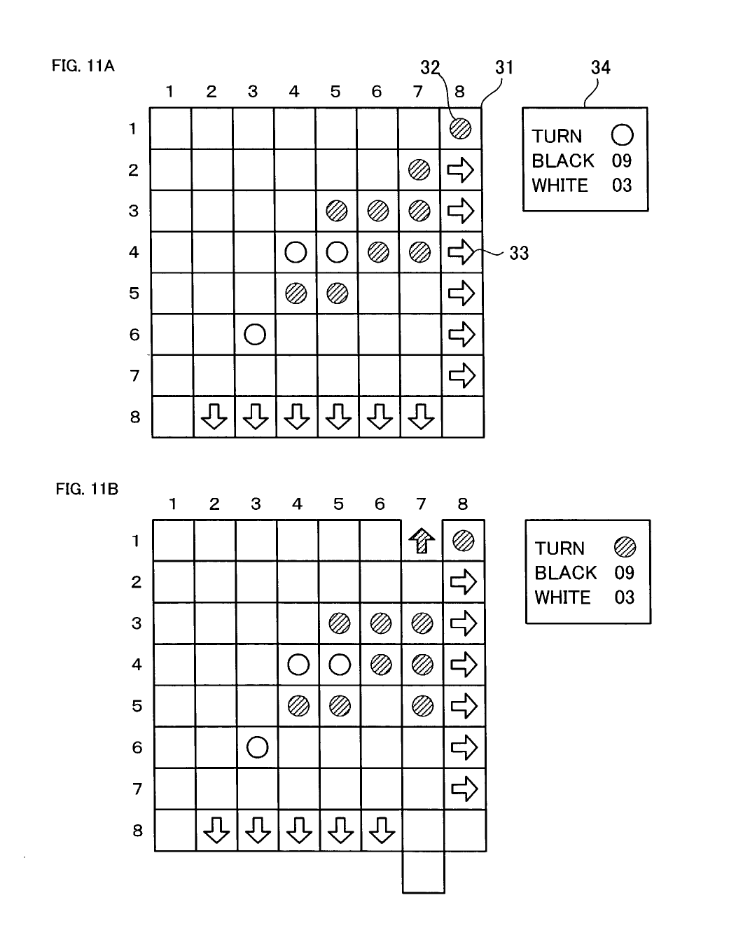

The game device main unit 1 also judges whether or not the row or column movement operation is a movement for returning the row or column to its original position (S53). If the operation is not one for returning to the original position, then the game device displays an arrow of a color having little difference in brightness to the background color on the opposite to the moved row or column in question (S54). For example, if the game board 31 is displayed in a dark color, then a black arrow is displayed (see FIG. 10 and FIG. 11). This arrow points in a direction returning the row or column in question to its original position. The moved row or column can be returned to its original position in accordance with this pointing arrow, and hence the board can eventually be returned to its original shape if it has temporarily a distorted shape.

However, this black arrow cannot be used by the opposing player at the next move (turn). Thereby, the opposing player is prevented from immediately returning the row or column to its previous position, and hence the movement of the rows or columns can be used effectively in a strategic fashion. After the player's operation at the next turn, the black arrow turns into an arrow of the same color as the other arrows (white), whereupon, by selecting the arrow, the row or column can be returned to its original position.

At S53, if the movement operation for the row or column is an operation for returning the row or column to its original position, then the sequence of processing is terminated without displaying a new arrow. Thereby, in the present embodiment, it is possible to move a row or column forwards and backwards again one time only. The number of times a row or column can be moved is limited because, if a row or column movement operation is performed, the number of pieces on the game board does not increase, and consequently, if this is repeated endlessly, the game will never come to an end. Moreover, restricting the number of movements to a small number makes the game easier to understand for a beginner. Furthermore, supposing that a game device of this kind is implemented in a computer, then the rows and columns can be moved freely, and the restriction on the number of movements of the rows and columns can be performed in an objective and reliable manner.

Merits of the Present Embodiment

By adopting a composition as described above, it is possible to implement a variety of surprising strategies such as those described in the practical examples below, and hence the game characteristics can be improved.

In the situation illustrated in FIG. 8A, if the white player moves the fifth column upwards, then almost all of the pieces in the sixth and seventh columns can be turned to white (FIG. 8B). Thereby, it is possible to reverse a greater number of pieces in one move than in a conventional reversi game, and the margin for creating a great upset is increased.

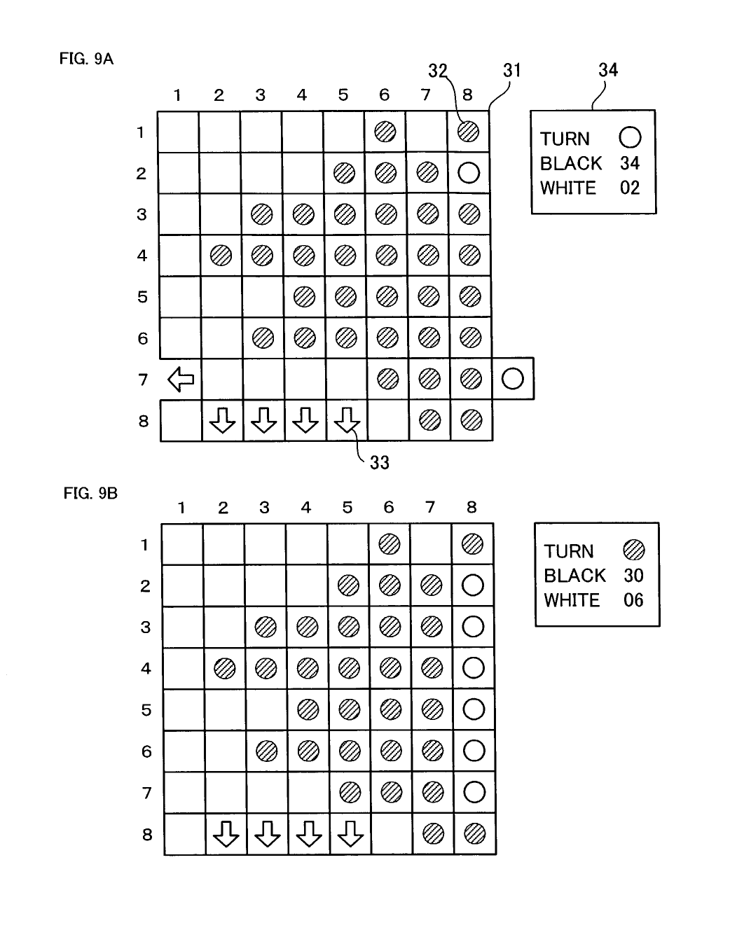

In the situation illustrated in FIG. 9A, if the white player moves the seventh row to the left, then it is possible to turn the end position, which has little chance of being reversed, to white (FIG. 9B). Thereby, it is possible to create an opening for reversal from a position of apparent inferiority, and hence it is possible to provide a game device which creates lasting game characteristics right up until the end of the game.

In the situation illustrated in FIG. 10A, if the black player moves the seventh line to the right (FIG. 10B), then no matter what move the white player makes next, at the subsequent black move, the corner square of the eighth row and eighth column can be taken. Therefore, a new strategy for taking corner squares can be created, and hence the enjoyment value of the game is increased.

In the situation illustrated in FIG. 11A, if the white player moves the seventh column downwards (FIG. 11B), then no matter what move the black player makes next, at the subsequent white move, regardless of the fact that there is a black square at the corner of the first row and the eighth column, the squares surrounding the corner can be turned white. Therefore, even if a corner has been taken, it is possible to nullify the effectiveness thereof in a strategic manner, thereby increasing the enjoyment value of the game.

According to the present invention, new strategic characteristics can be added to a conventional game, and hence it is possible to provide a reversi game device of excellent playability which incorporates reversal elements up until the end of the game.

What is claimed is:

1. A reversi game device comprising:
means for displaying on a screen a game board divided into individual piece laying positions by a plurality of rows and columns;
means for placing a piece having a prescribed color or symbol at a specified piece laying position, in accordance with a piece laying input specifying a piece laying position;
means for moving pieces of a specified row or column with respect to pieces of the other rows or columns, in accordance with a shift input specifying a row or column;
judging means for judging whether or not a piece having another color or symbol is trapped between (a) a piece laid by a piece laying input or moved by said shift input and (b) another piece having the same color or symbol as that of the piece laid or moved; and
means for changing the color or symbol of said trapped piece to the same color or symbol as the color or symbol of the pieces trapping same, on the basis of said judgment.

2. The reversi game device according to claim 1,
wherein said judging means carries out judgment of whether or not a piece is trapped only in the column direction, in cases where pieces of a specified row are moved in accordance with said shift input,
and wherein said judging means carries out judgment of whether or not a piece is trapped only in the row direction, in cases where pieces of a specified column are moved in accordance with said shift input.

3. The reversi game device according to claim 1 or claim 2, wherein the number of movements according to said shift input is limited.

4. The reversi game device according to claim 3, wherein the number of movements according to said shift input is limited to one forward and backward movement per row or per column.

5. A reversi game processing method comprising the steps of:
displaying on a screen a game board divided into individual piece laying positions by a plurality of rows and columns;
placing a piece having a prescribed color or symbol at a specified piece laying position, in accordance with a piece laying input specifying a piece laying position;
moving pieces of a specified row or column with respect to pieces of the other rows or columns, in accordance with a shift input specifying a row or column;
judging whether or not a piece having another color or symbol is trapped between (a) a piece laid by said piece laying input or moved by said shift input and (b) another piece having the same color or symbol as that of the piece laid or moved; and
changing said trapped piece to the same color or symbol as the color or symbol of the pieces trapping same, on the basis of said judgment.
